(19) United States
(12) Patent Application Publication
(10) Pub. No.: US 2022/0281435 A1
(43) Pub. Date: Sep. 8, 2022

(54) VEHICLE CONTROL DEVICE

(71) Applicant: HONDA MOTOR CO., LTD., Tokyo (JP)

(72) Inventors: Kenichiro OGATA, Tokyo (JP); Satoshi WATANABE, Tokyo (JP); Satoshi ANDO, Tokyo (JP)

(73) Assignee: HONDA MOTOR CO., LTD., Tokyo (JP)

(21) Appl. No.: 17/682,414

(22) Filed: Feb. 28, 2022

(30) Foreign Application Priority Data
Mar. 2, 2021 (JP) 2021-032995

(51) Int. Cl. B60W 20/17; F02N 11/04; F02D 41/04

(52) U.S. Cl. CPC B60W 20/17; F02N 11/04; F02D 41/042; B60K 6/40

(57) ABSTRACT

A vehicle control device controls a vehicle that includes an internal combustion engine, an electric motor, and a drive wheel driven that is capable of starting the internal combustion engine by cranking of the electric motor. When the internal combustion engine is started by cranking of the electric motor, the vehicle control device is configured to: control a power running torque of the electric motor based on an intake pressure of the internal combustion engine until the internal combustion engine goes into a complete combustion state; and control a regenerative torque of the electric motor based on a fuel injection amount of the internal combustion engine until a rotation speed of the internal combustion engine converges within a predetermined range including a target rotation speed, after the internal combustion engine goes into the complete combustion state.

### CROSS-REFERENCE TO RELATED APPLICATIONS

This application is based on and claims priority under 35 USC 119 from Japanese Patent Application No. 2021-032995 filed on Mar. 2, 2021, the contents of which are incorporated herein by reference.

### TECHNICAL FIELD

The present disclosure relates to a vehicle control device.

### BACKGROUND

In the related art, it is favorable to reduce vibration generated at the time of starting an internal combustion engine in a vehicle including an internal combustion engine. For example, JP-A-2020-045035 discloses a hybrid vehicle that includes an engine and a motor generator and that can start the engine by cranking of the motor generator, and discloses a technique in which the engine is configured to perform a valve timing control for advancing a closing timing of an intake valve of the engine so as to cross a bottom dead center when the engine is started, and when the valve timing control is performed, the motor generator is controlled so that an output torque of the motor generator is a torque obtained by adding a damping torque determined according to an intake pressure and the closing timing to a cranking torque required for cranking the engine.

JP-A-2004-222439 discloses a technique of detecting a torque pulsation generated in a torque from an internal combustion engine and controlling a motor generator so as to generate a decreasing torque having the same phase as the torque pulsation.

In a vehicle including an internal combustion engine, an electric motor coupled to the internal combustion engine, and a drive wheel driven by an output of at least one of the internal combustion engine and the electric motor, the internal combustion engine is started by cranking of the electric motor. In this case, in order to shorten a generation period of vibration that may cause a driver to feel uncomfortable, it is required to quickly start the internal combustion engine by increasing a power running torque of the electric motor at the time of starting the internal combustion engine.

On the other hand, when the power running torque of the electric motor is maintained after the internal combustion engine is started, a rotation speed of the internal combustion engine overshoots, which leads to deterioration of noise and vibration (NV) characteristics of the vehicle.

The present disclosure provides a vehicle control device that can appropriately start an internal combustion engine by cranking of an electric motor while preventing deterioration of NV characteristics of a vehicle.

### SUMMARY

One aspect of the present disclosure relates to a vehicle control device for controlling a vehicle that includes an internal combustion engine, an electric motor coupled to the internal combustion engine, and a drive wheel driven by an output of at least one of the internal combustion engine and the electric motor and that is capable of starting the internal combustion engine by cranking of the electric motor, in which when the internal combustion engine is started by cranking of the electric motor, the vehicle control device is configured to: control a power running torque of the electric motor based on an intake pressure of the internal combustion engine until the internal combustion engine goes into a complete combustion state; and control a regenerative torque of the electric motor based on a fuel injection amount of the internal combustion engine until a rotation speed of the internal combustion engine converges within a predetermined range including a target rotation speed, after the internal combustion engine goes into the complete combustion state.

According to the present disclosure, it is possible to provide a vehicle control device that can appropriately start an internal combustion engine by cranking of an electric motor while preventing deterioration of NV characteristics of a vehicle.

### BRIEF DESCRIPTION OF DRAWINGS

Exemplary embodiments of the present invention will be described in detail based on the following figures, wherein:

FIG. 1 is a diagram showing an example of a vehicle according to an embodiment;

FIG. 2 is a diagram showing an example of a transmission provided in the vehicle according to the embodiment;

FIG. 3A is a diagram showing an example of a control performed by a control device when an engine is started in a throttle closed state;

FIG. 3B is an enlarged view showing a motor torque, an engine rotation speed, and a fuel injection signal in a certain period immediately after a time t12 in FIG. 3A; and

FIG. 4 is a diagram showing an example of a control performed by the control device when the engine is started in a throttle open state.

### DESCRIPTION OF EMBODIMENTS

Hereinafter, an embodiment of a vehicle control device according to the present disclosure will be described in detail with reference to the drawings.

### Vehicle

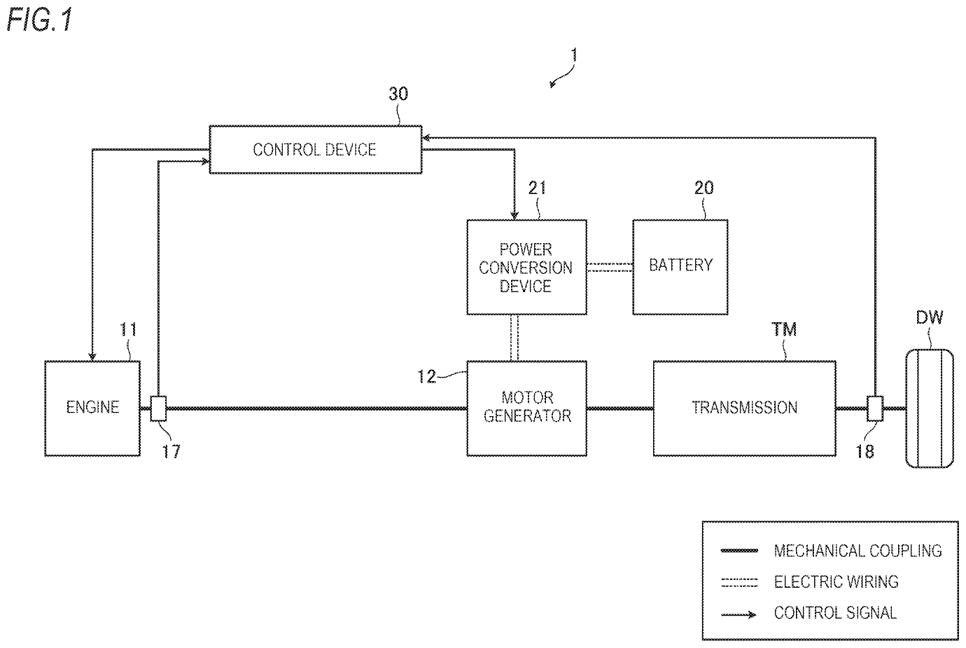

As shown in FIG. 1, a vehicle 1 according to the present embodiment is a so-called hybrid electrical vehicle, and includes an engine 11 that is an example of an internal combustion engine, a motor generator 12 that is an example of an electric motor, a transmission TM, a drive wheel DW, a battery 20, a power conversion device 21, and a control device 30 that controls the entire vehicle 1. In FIG. 1, a thick solid line indicates mechanical coupling, double broken lines indicate electric wiring, and a solid arrow indicates a control signal.

The engine 11 is, for example, a so-called cylinder deactivation engine configured to be switchable between an all-cylinder operation in which all cylinders are operated and a deactivated-cylinder operation in which some cylinders are deactivated. For example, the engine 11 is a V-type six-cylinder engine including a variable valve timing mechanism (not shown), and is configured such that three cylinders of one bank can be deactivated by the variable valve timing mechanism. That is, in the engine 11, a six-cylinder operation using six cylinders of both banks is performed during an all-cylinder operation, and a three-cylinder operation using only three cylinders of one bank is performed during a deactivated-cylinder operation. For example, the engine 11 is configured such that a valve opening period, a valve opening and closing timing, a lift amount, and the like of each intake valve can be changed by the variable valve timing mechanism.

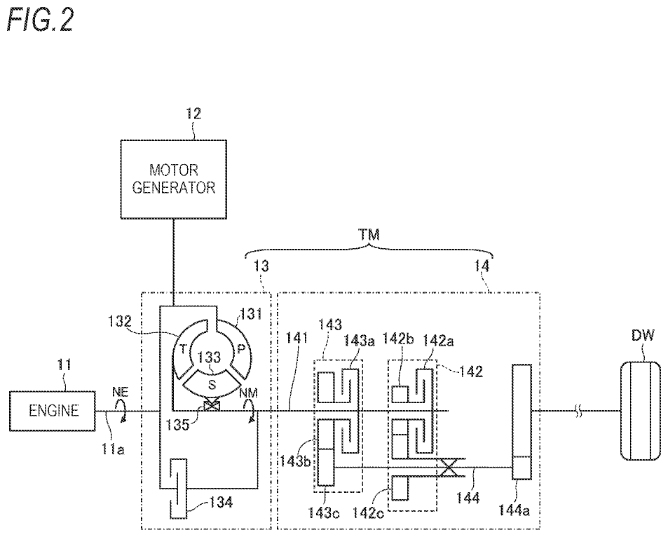

The engine 11 outputs mechanical energy (power) generated by burning supplied fuel (for example, gasoline) by rotationally driving a crankshaft 11a (see FIG. 2). Specifically, the engine 11 includes an injector (not shown). The injector is controlled by the control device 30 using a pulse width modulation (PWM) control, and supplies fuel to the engine 11.

Specifically, the injector is opened in a period corresponding to a pulse width of a pulse signal (voltage signal) that is received from the control device 30 and serves as a fuel injection signal, and injects fuel into each cylinder of the engine 11. Hereinafter, an amount of the fuel injected by the injector per pulse of the fuel injection signal is also referred to as a fuel injection amount. The fuel injection amount is proportional to a pulse width of the fuel injection signal, and can increase as the pulse width increases.

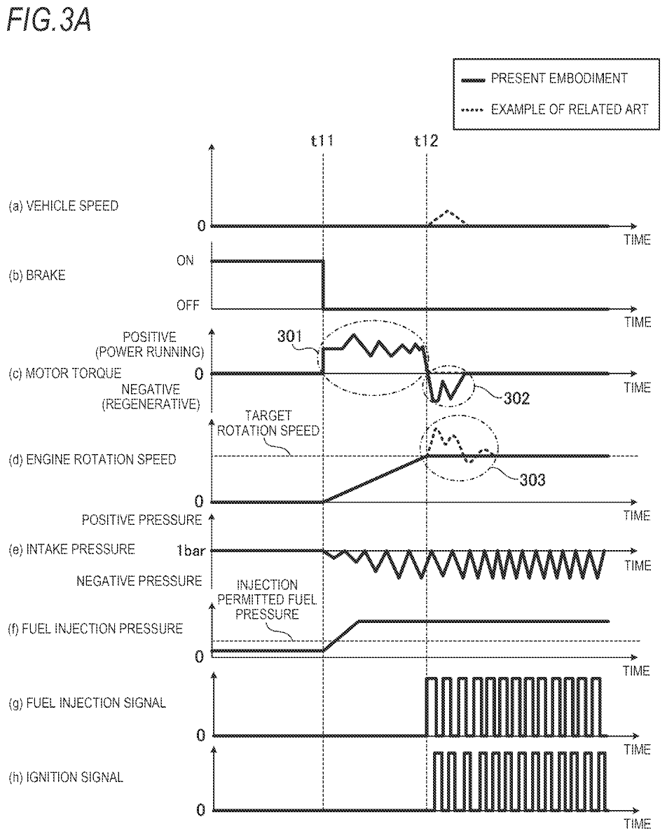

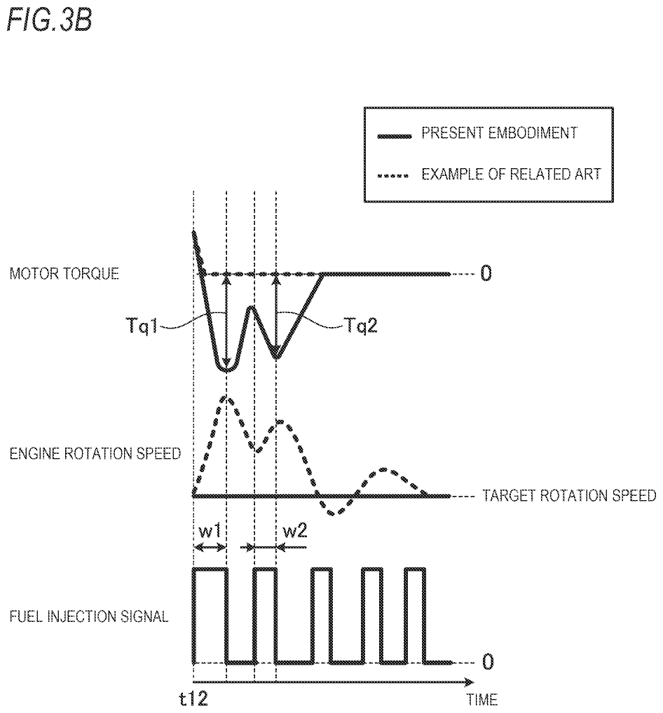

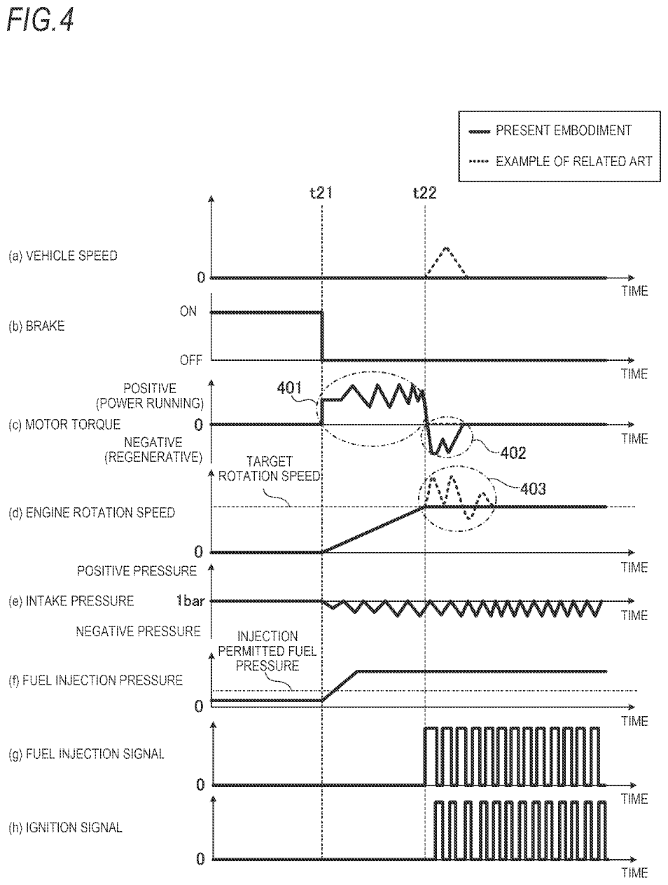

Fuel is supplied to the injector via an injection pump (not shown). The injection pump supplies fuel to the injector at a fuel injection pressure under the control of the control device 30. The fuel injection amount is also proportional to the fuel injection pressure, and can increase as the fuel injection pressure increases. For example, the injector can inject fuel into each cylinder of the engine 11 by supplying the fuel at a fuel injection pressure equal to or higher than a predetermined value (also referred to as an injection permitted fuel pressure, see FIGS. 3A and 4).

Power output from the engine 11 (hereinafter, also simply referred to as an output of the engine 11) by a fuel supply of the injector is transmitted to the drive wheel DW via the transmission TM that is mechanically coupled to the engine 11, and the power is used for traveling of the vehicle 1.

The engine 11 is also mechanically coupled to the motor generator 12. The motor generator 12 is, for example, a three-phase AC motor, and functions as an electric motor that outputs power by being supplied with electric power. Specifically, a rotor (not shown) of the motor generator 12 is coupled to the crankshaft 11a of the engine 11. Therefore, a crank end torque is the sum of a torque output from the engine 1 (hereinafter, also referred to as an engine torque) and a torque output from the motor generator 12 (hereinafter, also referred to as a motor torque). The crank end torque is a torque at a shaft end of the crankshaft 11a of a power plant torque output from a power plant including the engine 11 and the motor generator 12. In the following description, a positive (plus) motor torque is also referred to as a power running torque, and a negative (minus) motor torque is also referred to as a regenerative torque.

Since the engine 11 and the motor generator 12 are mechanically coupled to each other, the vehicle 1 can perform motor assist in which driving of the drive wheel DW (that is, traveling of the vehicle 1) using the output of the engine 11 is assisted by power output from the motor generator 12 (hereinafter, also simply referred to as an output of the motor generator 12).

Since the engine 11 and the motor generator 12 are mechanically coupled to each other, the motor generator 12 can be rotationally driven by the output of the engine 11, or the engine 11 can be rotationally driven by the output of the motor generator 12. Specifically, the engine 11 can be started by cranking of the motor generator 12 in the vehicle 1.

The motor generator 12 is electrically connected to the battery 20 via the power conversion device 21. The battery 20 is, for example, a battery that includes a plurality of electric power storage cells connected in series and can output a predetermined voltage (for example, 50 to 200 [V]). The electric power storage cells of the battery 20 may use a lithium ion battery, a nickel-metal hydride battery, or the like.

The power conversion device 21 is a device that includes an inverter (not shown), an AC-DC converter (not shown), and the like. The power conversion device 21 is controlled by the control device 30, and performs electric power conversion. For example, the power conversion device 21 converts DC electric power supplied from the battery 20 into three-phase AC electric power and supplies the three-phase AC electric power to the motor generator 12, or converts three-phase AC electric power supplied from the motor generator 12 into DC electric power and supplies the DC electric power to the battery 20. The motor generator 12 is supplied with electric power from the battery 20 via the electric power conversion device 21, so that the motor generator 12 can perform the motor assist described above.

The motor generator 12 also functions as a power generator that generates electric power by being rotationally driven. The motor generator 12 can be rotationally driven by the output of the engine 11 as described above, and can also be rotationally driven by power input from the drive wheel DW side accompanying with braking or the like of the vehicle 1. The electric power generated by the motor generator 12 is supplied to the battery 20 via the power conversion device 21, and is used to charge the battery 20.

The transmission TM is a multistage transmission having a plurality of shift stages (for example, seven shift stages), and is provided in a power transmission path from the engine 11 to the drive wheel DW. Specifically, the transmission TM includes a torque converter 13 and a gear box 14 as shown in FIG. 2.

The torque converter 13 includes a pump impeller 131, a turbine runner 132, a stator 133, and a lock-up clutch 134. The pump impeller 131 is mechanically coupled to the engine 11 and the motor generator 12 (specifically, the crankshaft 11a), and rotates integrally with the engine 11 and the motor generator 12 when the engine 11 and the motor generator 12 are rotationally driven. The turbine runner 132 has a hydraulic oil inlet located close to a hydraulic oil outlet of the pump impeller 131. The turbine runner 132 is mechanically coupled to an input shaft 141 of the gear box 14, and rotates integrally with the input shaft 141. The stator 133 is interposed between the turbine runner 132 and the pump impeller 131, and deflects a flow of hydraulic oil returning from the turbine runner 132 to the pump impeller 131. The stator 133 is supported by a housing (not shown) or the like of the torque converter 13 via a one-way clutch 135. The torque converter 13 can transmit power (rotation power) from the pump impeller 131 to the turbine runner 132 via the hydraulic oil by circulating the hydraulic oil in a circulation path formed between the pump impeller 131 and the turbine runner 132.

The lock-up clutch 134 is a clutch capable of mechanically connecting the engine 11 to and disconnecting the engine 11 from the input shaft 141 of the gearbox 14. An output of the engine 11 can be directly transmitted to the input shaft 141 of the gearbox 14 by bringing the lock-up clutch 134 into an engaged state. That is, when the lock-up clutch 134 is in the engaged state, the crankshaft 11a of the engine 11 and the input shaft 141 of the gear box 14 rotate integrally.

The gearbox 14 includes the input shaft 141 to which the output of the engine 11 or the motor generator 12 is transmitted via the torque converter 13, a plurality of transmission mechanisms 142 and 143 capable of shifting power transmitted to the input shaft 141, and an output member 144 including an output gear 144a that outputs the power shifted by any one of the plurality of transmission mechanisms to the drive wheel DW.

The plurality of transmission mechanisms provided in the gearbox 14 include a first transmission mechanism 142 and a second transmission mechanism 143. The first transmission mechanism 142 includes a first transmission clutch 142a, a first drive gear 142b that rotates integrally with the input shaft 141 when the first transmission clutch 142a is in an engaged state, and a first driven gear 142c that rotates integrally with the output member 144. The second transmission mechanism 143 includes a second transmission clutch 143a, a second drive gear 143b that rotates integrally with the input shaft 141 when the second transmission clutch 143a is in an engaged state, and a second driven gear 143c that rotates integrally with the output member 144.

Although FIG. 2 only shows the first transmission mechanism 142 and the second transmission mechanism 143 as the transmission mechanisms provided in the gear box 14, the gear box 14 also includes, for example, transmission mechanisms (not shown) other than the first transmission mechanism 142 and the second transmission mechanism 143.

Whether each clutch provided in the transmission TM such as the lock-up clutch 134, the first transmission clutch 142a, and the second transmission clutch 143a (hereinafter, also simply referred to as a clutch of the transmission TM) goes into an engaged state or a disengaged state is controlled by the control device 30.

Returning to FIG. 1, the control device 30 is a device that controls the engine 11, the transmission TM, the power conversion device 21, and the like. The control device 30 can also control the motor generator 12 via controlling the power conversion device 21. The control device 30 is implemented by, for example, an electronic control unit (ECU) including a processor that executes various calculations, a storage device that stores various types of information, an input and output device that controls data input and output between an inner side and an outer side of the control device 30, and the like. The control device 30 may be implemented by a single ECU, or may be implemented by cooperation of a plurality of ECUs.

Various sensors are connected to the control device 30, and the control device 30 controls the engine 11, the transmission TM, the power conversion device 21 (that is, the motor generator 12), and the like based on information input from the various sensors. Examples of sensors connected to the control device 30 include a rotation speed sensor 17 that detects a rotation speed of the engine 11 (the crankshaft 11a) (hereinafter, also referred to as an engine rotation speed) and a vehicle speed sensor 18 that detects a speed of the vehicle 1 (hereinafter, also referred to as a vehicle speed). Further, examples of the sensors connected to the control device 30 include an AP sensor that detects an operation amount (hereinafter, referred to as an AP opening degree) on an accelerator pedal, a brake sensor that detects an operation amount on a brake pedal, a gear position sensor that detects a shift stage of the transmission TM, a battery sensor that detects an output or a temperature of the battery 20, and an intake pressure sensor that detects an intake pressure of the engine 11 (all of the sensors described above are not shown). In addition, an atmospheric pressure sensor (not shown) that detects an atmospheric pressure may be connected to the control device 30.

For example, the control device 30 derives a target torque for a crank end torque (hereinafter, also referred to as a crank end required torque) that is the sum of an engine torque and a motor torque, based on a traveling state of the vehicle 1. For example, the control device 30 derives the crank end required torque by referring to the vehicle speed detected by the vehicle speed sensor 18, the AP opening degree detected by the AP sensor, and a map that defines the crank end required torque required for traveling of the vehicle 1 in accordance with the vehicle speed and the AP opening degree. For example, the map is stored in advance in the storage device of the control device 30. The control device 30 controls the engine torque and the motor torque so that the crank end torque becomes the crank end required torque.

The control device 30 switches an operation state of the engine 11 between the all-cylinder operation and the deactivated-cylinder operation based on the crank end required torque. Specifically, the control device 30 controls the engine 11 in the deactivated-cylinder operation when the crank end required torque is relatively small, and controls the engine 11 in the all-cylinder operation when the crank end required torque becomes large to some extent. That is, the control device 30 improves fuel consumption performance of the vehicle 1 by operating the engine 11 in the deactivated-cylinder operation when the crank end required torque is small, and ensures an appropriate crank end torque according to a traveling state of the vehicle 1 by operating the engine 11 in the all-cylinder operation when the crank end required torque is large.

When a predetermined stop condition is satisfied, the control device 30 executes an idling stop control for stopping the operation (idling) of the engine 11. Examples of the stop condition include a condition in which the vehicle 1 is in a low speed state or a stopped state (that is, the vehicle speed is equal to or less than a threshold) in response to a deceleration request to the vehicle 1. The deceleration request is, for example, a brake on request for operating (for example, depressing) a brake pedal of the vehicle 1, an accelerator off request for releasing an operation on an accelerator pedal of the vehicle 1, or the like.

In a case where there is an acceleration request to the vehicle 1 when the operation of the engine 11 is stopped by the idling stop control, the control device 30 starts (that is, restarts) the engine 11. The acceleration request is, for example, a brake off request for releasing an operation on the brake pedal of the vehicle 1, an accelerator on request for operating the accelerator pedal, or the like.

When the engine 11 is started, the control device 30 starts the engine 11 by cranking of the motor generator 12. In order to shorten a generation period of vibration that may cause a driver to feel uncomfortable when the engine 11 is started, it is required to quickly start the engine 11 by increasing the power running torque of the motor generator 12 at the time of starting the engine 11. On the other hand, when the power running torque of the motor generator 12 is maintained even after the engine 11 is started, the engine rotation speed overshoots, which leads to deterioration of noise and vibration (NV) characteristics of the vehicle 1. When the engine rotation speed overshoots in this manner, creep in the vehicle 1 becomes too strong, and the vehicle 1 may jump out against an intention of the driver.

Therefore, when the engine 11 is started by cranking of the motor generator 12, the control device 30 controls the power running torque of the motor generator 12 based on an intake pressure of the engine 11 until the engine 11 goes into a complete combustion state. Specifically, at this time, the control device 30 controls the power running torque to be a torque obtained by adding a damping torque determined based on the intake pressure to a cranking torque required for cranking the engine 11. For example, the control device 30 determines the damping torque based on a negative pressure amount that is a difference between the intake pressure and the atmospheric pressure. Accordingly, the damping torque can be determined to have a magnitude corresponding to a compression reaction force of the engine 11.

As described above, the control device 30 controls the power running torque of the motor generator 12 based on the intake pressure of the engine 11 until the engine 11 goes into the complete combustion state, so that the engine can be quickly started while preventing the vibration that may cause a driver to feel uncomfortable. For example, when the engine rotation speed is equal to or higher than a predetermined rotation speed (for example, 1000 [rpm]), the control device 30 determines that the engine 11 goes into the complete combustion state.

After the engine 11 goes into the complete combustion state, the control device 30 controls a regenerative torque of the motor generator 12 based on a fuel injection amount to the engine 11. For example, the control device 30 controls the regenerative torque with reference to a map in which the fuel injection amount (or an engine torque output from the engine 11 in accordance with a fuel supply at the fuel injection amount, that is, a combustion torque to be described later) and the regenerative torque are associated with each other. For example, the map is stored in advance in the storage device of the control device 30. Then, the control device 30 continues the control of the regenerative torque based on the fuel injection amount until the engine rotation speed converges within a predetermined range including a target rotation speed (for example, 1000 [rpm]). For example, the target rotation speed and the predetermined range are set in advance in the control device 30.

Specifically, at this time, the control device 30 controls the regenerative torque so as to match the engine torque (also referred to as a combustion torque) output from the engine 11 according to a fuel supply of an injector. Accordingly, it is possible to prevent the engine rotation speed from overshooting when the engine 11 is started, thereby preventing deterioration of the NV characteristics of the vehicle 1 and preventing the vehicle 1 from jumping out against the intention of a driver.

Hereinafter, an example of the control executed by the control device 30 will be specifically described. Each example described below is an example of a case where the engine 11 stopped by the idling stop control is started (that is, restarted).

### Throttle Closed Start

First, an example of a case where the engine 11 is started when a throttle of the vehicle 1 is in a closed state (that is, an accelerator off state. Hereinafter, also simply referred to as a throttle closed state) will be described with reference to FIGS. 3A and 3B. FIG. 3A shows a relationship among times of (a) a vehicle speed, (b) a brake, (c) a motor torque, (d) an engine rotation speed, (e) an intake pressure, (f) a fuel injection pressure, (g) a fuel injection signal, and (h) an ignition signal (that is, an ignition time of the engine 11). FIG. 3B is an enlarged view showing the motor torque, the engine rotation speed, and the fuel injection signal in a certain period immediately after a time t12 in FIG. 3A.

At a time t11 shown in FIG. 3A, since the brake is turned off by a driver, the control device 30 starts cranking of the engine 11 by the motor generator 12 in order to start the engine 11 that was stopped by the idling stop control. At this time, the control device 30 first sets a control mode of the motor generator 12 to a first mode. Here, the first mode is a control mode determined so as to control a torque of the motor generator 12 based on the intake pressure of the engine 11.

Then, the control device 30 controls the torque of the motor generator 12 in the first mode until the engine 11 goes into a complete combustion state (see a portion surrounded by a dashed line denoted by a reference numeral 301 in FIG. 3A). In this manner, when the first mode is set, the control device 30 controls the power running torque of the motor generator 12 to be a torque obtained by adding a damping torque to a cranking torque. Accordingly, it is possible to quickly start the engine 11 while preventing vibration that may cause a driver to feel uncomfortable, simplifying the control of the control device 30, and reducing a processing load of the control device 30.

More specifically, when the first mode is set, the control device 30 executes a control such that the power running torque of the motor generator 12 increases as a negative pressure amount of the intake pressure decreases. As a result, it is possible to effectively prevent vibration caused by a compression reaction force at the time of starting the engine 11. When the first mode is set, the control device 30 may control the torque (the power running torque) of the motor generator 12 in consideration of a closing timing of the intake valve and the like in addition to the intake pressure.

At the time t12 after the time t11 shown in FIG. 3A, when the engine 11 goes into a complete combustion state, the control device 30 sets (changes) the control mode of the motor generator 12 to a second mode. Here, the second mode is a control mode determined so as to control the torque of the motor generator 12 based on a fuel injection amount, that is, a pulse width of a fuel injection signal.

Then, the control device 30 controls the torque of the motor generator 12 in the second mode until the engine rotation speed converges within a predetermined range (for example, the target rotation speed) (see a portion surrounded by a dashed line denoted by a reference numeral 302 in FIG. 3A). When the second mode is set in this manner, the control device 30 controls the regenerative torque of the motor generator 12 so as to match the combustion torque. As a result, it is possible to prevent the engine rotation speed from overshooting when the engine 11 is started while simplifying the control of the control device 30 and reducing a processing load of the control device 30, thereby preventing deterioration of the NV characteristics of the vehicle 1 and preventing the vehicle 1 from jumping out against the intention of a driver.

The combustion torque may increase in proportion to the fuel injection amount. Therefore, when the control device 30 controls the regenerative torque based on the fuel injection amount, the control device 30 may increase the regenerative torque as the fuel injection amount increases. Specifically, the larger the pulse width of the fuel injection signal is, the larger the fuel injection amount can be. Therefore, the control device 30 may increase the regenerative torque as the pulse width of the fuel injection signal increases.

For example, when the pulse width of the fuel injection signal is w1, the control device 30 controls the regenerative torque to be Tq1, as shown in FIG. 3B. On the other hand, when the pulse width of the fuel injection signal is w2 that is smaller than w1, the control device 30 controls the regenerative torque to be Tq2 that is smaller than Tq1. As a result, the regenerative torque can be controlled so as to match the combustion torque, and the engine rotation speed can be prevented from overshooting. As the fuel injection pressure increases, the fuel injection amount can be increased. Therefore, the control device 30 may increase the regenerative torque as the fuel injection pressure increases.

As described above, when the engine 11 that was stopped by the idling stop control is started in the throttle closed state, the control device 30 sets a control mode to the first mode to control the power running torque of the motor generator 12 until the engine 11 goes into the complete combustion state, and sets a control mode to the second mode to control the regenerative torque of the motor generator 12 after the engine 11 goes into the complete combustion state, so that it is possible to appropriately start the engine 11 by cranking of the motor generator 12 while preventing the deterioration of the NV characteristics of the vehicle 1.

On the other hand, in an example of the related art as shown in FIG. 3A, when the motor torque is set to 0 after the engine 11 goes into the complete combustion state and a control for matching the regenerative torque with the combustion torque is not executed, the engine rotation speed exceeds the target rotation speed and overshoots as indicated by a portion surrounded by a dashed line denoted by a reference numeral 303. As a result, the NV characteristics deteriorate, or a vehicle jumps out (a period in which the vehicle speed>0) against the intention of a driver.

A method of deriving or measuring the engine torque output from the engine 11 and controlling the regenerative torque so as to match the derived or measured engine torque is also conceivable. However, since the control of the regenerative torque is delayed relative to the engine torque in this method, the engine rotation speed may overshoot, the NV characteristics may deteriorate, or the vehicle may jump out against the intention of a driver due to such a delay.

In this regard, since the control device 30 according to the present embodiment controls the regenerative torque based on the fuel injection amount as described above, it is possible to accurately control the regenerative torque so as to match the engine torque while preventing the delay of the control of the regenerative torque relative to the engine torque.

### Throttle Open Start

Next, an example of a case where the engine 11 is started when a throttle of the vehicle 1 is in an open state (that is, an accelerator on state. Hereinafter, also simply referred to as a throttle open state) will be described with reference to FIG. 4. Similar to FIG. 3A, FIG. 4 shows a relationship among times of (a) a vehicle speed, (b) a brake, (c) a motor torque, (d) an engine rotation speed, (e) an intake pressure, (f) a fuel injection pressure, (g) a fuel injection signal, and (h) an ignition signal (that is, an ignition time of the engine 11). In the following description of FIG. 4, portions different from those in FIG. 3A will be mainly described, and description of the same portions as those in FIG. 3A will be omitted or simplified as appropriate.

At a time t21 shown in FIG. 4, since the brake is turned off and the accelerator is turned on by a driver, the control device 30 starts cranking of the engine 11 by the motor generator 12 in order to start the engine 11 that was stopped by the idling stop control. Similar to the example in FIG. 3A, at this time, the control device 30 first sets the control mode of the motor generator 12 to the first mode, and controls the power running torque of the motor generator 12 in the first mode until the engine 11 goes into the complete combustion state (see a portion surrounded by a dashed line denoted by a reference numeral 401 in FIG. 4).

In the throttle open state, the negative pressure amount of the intake pressure is smaller than that in the throttle closed state shown in FIG. 3A and the like. Therefore, an average value of the power running torque in a period up to when the engine 11 goes into the complete combustion state is larger in the throttle open state than that in the throttle closed state.

At a time t22 after the time t21 shown in FIG. 4, when the engine 11 goes into the complete combustion state, the control device 30 sets (changes) the control mode of the motor generator 12 to the second mode, and controls the regenerative torque of the motor generator 12 in the second mode until the engine rotation speed converges within a predetermined range (for example, the target rotation speed) (see a portion surrounded by a dashed line denoted by a reference numeral 402 in FIG. 4).

In the throttle open state, the fuel injection amount immediately after the engine 11 goes into the complete combustion state is larger than that in the throttle closed state shown in FIG. 3A and the like. In other words, the pulse width of the fuel injection signal immediately after the engine 11 goes into the complete combustion state is larger in the throttle open state than that in the throttle closed state. Therefore, as compared with the throttle closed state, the control device 30 increases the regenerative torque immediately after the engine 11 goes into the complete combustion state in the throttle open state. For example, the control device 30 maximizes a regeneration amount of the motor generator 12 immediately after the engine 11 goes into the complete combustion state. For example, the control device 30 retards an ignition time of the engine 11 in the throttle open state as compared with an ignition time in the throttle closed state.

As described above, when the engine 11 that was stopped by the idling stop control is started in the throttle open state, the control device 30 sets a control mode to the first mode to control the power running torque of the motor generator 12 until the engine 11 goes into the complete combustion state, and sets a control mode to the second mode to control the regenerative torque of the motor generator 12 after the engine 11 goes into the complete combustion state, so that it is possible to appropriately start the engine 11 by cranking of the motor generator 12 while preventing the deterioration of the NV characteristics of the vehicle 1.

On the other hand, in an example of the related art as shown in FIG. 4, when the motor torque is set to 0 after the engine 11 goes into the complete combustion state and a control for matching the regenerative torque with the combustion torque is not executed, the engine rotation speed exceeds the target rotation speed and overshoots as indicated by a portion surrounded by a dashed line denoted by a reference numeral 403. As a result, the NV characteristics deteriorate, or a vehicle jumps out (a period in which the vehicle speed>0) against the intention of a driver.

Although the embodiment of the present disclosure has been described above, the present disclosure is not limited to the embodiment described above, and modifications, improvements, and the like can be made as appropriate.

For example, although an example is described in the embodiment described above in which the engine 11 that was stopped by the idling stop control is started, the present disclosure is not limited thereto. The motor generator 12 may be controlled in the same manner as in the embodiment described above even when the engine 11 is started at another time.

At least the following matters are described in the present specification. Although corresponding components or the like in the embodiment described above are shown in parentheses, the present disclosure is not limited thereto.

(1) A vehicle control device (the control device 30) for controlling a. vehicle (the vehicle 1) that includes an internal combustion engine (the engine 11), an electric motor (the motor generator 12) coupled to the internal combustion engine, and a drive wheel (the drive wheel DW) driven by an output of at least one of the internal combustion engine and the electric motor and that can start the internal combustion engine by cranking of the electric motor, in which

when the internal combustion engine is started by cranking of the electric motor, the vehicle control device is configured to
control a power running torque of the electric motor based on an intake pressure of the internal combustion engine until the internal combustion engine goes into a complete combustion state, and
control a regenerative torque of the electric motor based on a fuel injection amount to the internal combustion engine until a rotation speed of the internal combustion engine converges within a predetermined range including a target rotation speed after the internal combustion engine goes into the complete combustion state.

According to (1), when the internal combustion engine is started by cranking of the electric motor, the vehicle control device controls the power running torque of the electric motor based on the intake pressure of the internal combustion engine until the internal combustion engine goes into the complete combustion state, and after the internal combustion engine goes into the complete combustion state, the vehicle control device controls the regenerative torque of the electric motor based on the fuel injection amount to the internal combustion engine until the rotation speed of the internal combustion engine converges within the predetermined range including the target rotation speed. Accordingly, it is possible to appropriately start the internal combustion engine by cranking of the electric motor while preventing the deterioration of the noise and vibration (NV) characteristics of the vehicle.

(2) The vehicle control device according to (1), in which

when a predetermined stop condition is satisfied, the vehicle control device is configured to execute an idling stop control for stopping an operation of the internal combustion engine,

when the internal combustion engine that was stopped by the idling stop control is started,

the vehicle control device is configured to:
control the power running torque based on the intake pressure until the internal combustion engine goes into the complete combustion state; and
control the regenerative torque based on the fuel injection amount until the rotation speed converges within the predetermined range, after the internal combustion engine goes into the complete combustion state.

According to (2), when the internal combustion engine that was stopped by the idling stop control is started, the vehicle control device controls the power running torque of the electric motor based on the intake pressure until the internal combustion engine goes into the complete combustion state, and after the internal combustion engine goes into the complete combustion state, the vehicle control device controls the regenerative torque of the electric motor based on the fuel injection amount until the rotation speed of the internal combustion engine converges within the predetermined range. Accordingly, after the idling stop control, it is possible to appropriately start the internal combustion engine by cranking of the electric motor while preventing the deterioration of the NV characteristics of the vehicle.

(3) The vehicle control device according to (1) or (2), in which

the vehicle control device is configured to set a control mode of the electric motor to a first mode for controlling a torque of the electric motor based on the intake pressure, or a second mode for controlling the torque of the electric motor based on the fuel injection amount,

the vehicle control device is configured to set the control mode to the first mode until the internal combustion engine goes into the complete combustion state, and

the vehicle control device is configured to set the control mode to the second mode after the internal combustion engine goes into the complete combustion state.

According to (3), it is possible to appropriately start the internal combustion engine while simplifying the control of the vehicle control device and reducing a processing load.

(4) The vehicle control device according to any one of (1) to (3), in which

when the regenerative torque is controlled based on the fuel injection amount, the regenerative torque is increased as the fuel injection amount increases.

According to (4), the regenerative torque can be controlled to match a torque (a combustion torque) of the internal combustion engine that can be increased in proportion to the fuel injection amount, and the rotation speed of the internal combustion engine can be prevented from overshooting.

1. A vehicle control device for controlling a vehicle that includes an internal combustion engine, an electric motor coupled to the internal combustion engine, and a drive wheel driven by an output of at least one of the internal combustion engine and the electric motor and that is capable of starting the internal combustion engine by cranking of the electric motor,
wherein when the internal combustion engine is started by cranking of the electric motor,
the vehicle control device is configured to:
control a power running torque of the electric motor based on an intake pressure of the internal combustion engine until the internal combustion engine goes into a complete combustion state; and
control a regenerative torque of the electric motor based on a fuel injection amount of the internal combustion engine until a rotation speed of the internal combustion engine converges within a predetermined range including a target rotation speed, after the internal combustion engine goes into the complete combustion state.

2. The vehicle control device according to claim 1,
wherein when a predetermined stop condition is satisfied, the vehicle control device is configured to execute an idling stop control for stopping an operation of the internal combustion engine, and
wherein when the internal combustion engine that was stopped by the idling stop control is started,
the vehicle control device is configured to:
control the power running torque based on the intake pressure until the internal combustion engine goes into the complete combustion state; and
control the regenerative torque based on the fuel injection amount until the rotation speed converges within the predetermined range, after the internal combustion engine goes into the complete combustion state.

3. The vehicle control device according to claim 1,
wherein the vehicle control device is configured to set a control mode of the electric motor to a first mode for controlling a torque of the electric motor based on the intake pressure, or a second mode for controlling the torque of the electric motor based on the fuel injection amount,
wherein the vehicle control device is configured to set the control mode to the first mode until the internal combustion engine goes into the complete combustion state, and
wherein the vehicle control device is configured to set the control mode to the second mode after the internal combustion engine goes into the complete combustion state.

4. The vehicle control device according to claim 1,
wherein when the regenerative torque is controlled based on the fuel injection amount, the regenerative torque is increased as the fuel injection amount increases.
